(19) United States
(12) Patent Application Publication
(10) Pub. No.: US 2015/0053145 A1
(43) Pub. Date: Feb. 26, 2015

(54) LEASH ASSEMBLY WITH QUICK RELEASE APPARATUS

(71) Applicant: Pawgear, Inc., DBA Paww, San Francisco, CA (US)

(72) Inventors: Christopher A. MIKSOVSKY, San Francisco, CA (US); Clint N. SLONE, San Francisco, CA (US)

(73) Assignee: Pawgear, Inc., DBA Paww, San Francisco, CA (US)

(21) Appl. No.: 14/010,291

(22) Filed: Aug. 26, 2013

(51) Int. Cl. A01K 27/00

(52) U.S. Cl. CPC A01K 27/003; A01K 27/008
USPC 119/772; 29/428

(57) ABSTRACT

A leash assembly that includes an elongated strap device having a distal portion, a central portion and a strap proximal portion that enables gripping of the leash assembly thereof. A central quick release assembly includes a slide fastener member and a mating lock/slide fastener member. The slide fastener member includes a slide portion slidingly disposed at a plurality of positions along the strap central portion. The lock/slide fastener member includes a second fastening component adapted to releasably mate with a first fastening component of the fastener member. The lock/slide fastener member additionally includes a lock/slide portion slidingly disposed along a plurality of positions along the strap central portion in one orientation, and is further capable of releasably locking to the strap device in a second orientation. The first and second fastening components, cooperate for quick mounting to one of a plurality of varying diameter anchoring objects (e.g., a pole).

### FIELD OF THE INVENTION

The present invention relates to animal leashes, and more particularly, relates to dog leashes assemblies capable of quickly securing to an anchoring object.

### BACKGROUND OF THE INVENTION

Conventional animal leashes typically require the user to maintain a proximate end of the leash in at least one hand in order to control the animal on the other distal end. As part of the control, such leash of course limits the distance that the dog can travel in relation to its caretaker. At the leash proximate end, the leash strap typically forms a closed hand loop which not only aids gripping and maintaining control of the leash, but also facilitates securing the leashed animal to an object.

For conventional leashes, when securing a leashed dog to an object, such as a pole, the leash strap can be wrapped around the pole and threaded through the hand loop. Upon pulling the distal end of the leash, the proximal end thereof that extends through the hand loop and can be tightened around the pole to secure the animal.

One problem associated with this technique, however, is that initially the leashed animal must first be unleashed so that this leash distal end can be placed through the handle loop. Typically a dog owner, for instance, will grip the dog's collar for control of the dog, and unhook the distal leash hook from the dog collar with the other hand. While maintaining grip of the dog's collar, the owner must wrap the leash around the anchoring objection, and manipulate the distal leash hook through the proximate handle loop. This of course can be problematic should control of the animal not be maintained during this task.

Another problem encountered with this manner of securing a leashed animal to an object is that this method is overly laborious, cumbersome and relatively time consuming to implement.

Another issue with conventional leashes, when applying this securing technique, is that the distance that the animal is tethered from the object is more or less fixed. Should the leash be too long for whatever reason, shortening of the tether requires forming a knot in the leash or doing nothing at all.

Accordingly, there is a need for an animal leash that can be quickly and easily mounted to an object, while at the same time allowing the care taker to adjust the length of the tether.

### SUMMARY OF THE INVENTION

The present invention provides a leash assembly that includes an elongated strap device having a proximal portion, a distal portion and a central portion generally extending between the proximal and distal portion thereof. The strap proximal portion is configured to enable gripping of the leash assembly thereof, and the distal portion is configured to removably couple to an animal. In accordance with the present invention, the leash assembly further includes a quick release assembly, mounted to the strap central portion, having a slide fastener member and a spaced apart lock/slide fastener member. The slide fastener member includes a first fastening component and a slide portion configured for selective sliding disposal at a plurality of positions along the strap central portion. In contrast, the lock/slide fastener member includes a second fastening component adapted to releasably mate with the first fastening component. The lock/slide fastener member further includes a lock/slide portion capable of releasably locking to the strap device in a first orientation, and is further capable of selective sliding disposal thereof at a plurality of positions along the strap central portion at a second orientation. The first and second fastening components cooperate to selectively retain the central portion of the strap device to one of a plurality of varying diameter anchoring objects.

Accordingly, a leash assembly is provided that enables quick and safe securement of the strap device to an anchoring object that does not require unleashing of the animal from the leash during this process. Moreover, the leash is capable of accommodating a variety of anchoring object sizes, within the length constraints of the leash. In addition, the length that the animal is tethered from the anchoring object is adjustable, within the length constraints of the strap central portion.

In one specific embodiment, the first and second fastening components include corresponding press-fit buckle members configured for press-fit coupling to one another.

In another configuration, one of the press-fit buckle members is a male-type buckle member and the other press-fit buckle member is a female-type buckle member.

In still another embodiment, the male-type buckle member is oriented in a manner facing in the longitudinal direction toward the female-type buckle member.

Yet another embodiment provides the slide portion with a square link slide device, and the lock/slide portion with a three-bar slide device.

In one specific embodiment, the lock/slide fastener member is oriented along the strap device upstream from the slide fastener member.

In another specific embodiment, the leash assembly further includes a collar clip device having a proximal retaining loop. The strap distal portion further includes a first section of the distal portion of the strap device that extends through the retaining loop, and extends back towards and opposed to a second section of the distal portion. The first section of the strap distal portion 23 is affixed to the second section thereof proximate to the proximal retaining loop of the clip device, at a first mount. This retains the clip device at a distal end of the leash assembly. Moreover, the first section of the strap distal portion is mounted to the second section, at a second mount, spaced apart from the first mount and in a manner forming a distal hand loop proximate to the collar clip device.

In accordance with another aspect of present invention, a flexible pouch assembly is provided that is mounted to the proximal portion of the strap device. The pouch assembly includes an elongated, hollow body extending generally along a longitudinal axis thereof. The hollow body includes an upper sheet section and an opposed lower sheet section. The upper sheet section defines an opening into a cavity of the flexible body. The pouch assembly further includes a retaining section disposed adjacent to the lower sheet section. Collectively, a strap channel is formed extending generally in the direction of the longitudinal axis thereof. The strap channel is sized and dimensioned for sliding receipt of a transverse cross-sectional dimension of the strap device therethrough.

In one specific embodiment, the pouch assembly includes a proximal mount device configured to removably mount to the proximal control loop in a manner retaining the pouch assembly proximally along the strap device.

In another embodiment, the proximal mount device includes a strap member.

In yet another configuration, the hollow body includes a pair of opposed side walls extending between the upper sheet section and the lower sheet section. Each side wall includes a longitudinally extending central crease such that when the hollow body is empty, the hollow body can be moved to a relatively flat position.

In still another specific embodiment, one of the sidewalls defines an elongated dispensing slit that is formed and dimensioned for dispensing a flatten object therethrough.

Yet another embodiment includes the retaining section with an elastic portion enabling resilient expansion of the strap channel.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawings, in which:

FIG. 1 is a top perspective view of a leash assembly constructed in accordance with the present invention.

FIG. 2 is top perspective view of the leash assembly of FIG. 1, showing use of a quick release apparatus being mounted to a pole.

FIG. 3 is top perspective view of the leash assembly of FIG. 1, showing the quick release apparatus mounted to a pole.

FIG. 4 is a side elevation view of the leash assembly of FIG. 1.

FIGS. 5A and 5B are top perspective view of the quick release apparatus of the leash assembly of FIG. 1, illustrating locking movement of one of the buckles.

FIG. 6 is a top perspective view of a pouch assembly for the leash assembly of FIG. 1.

FIG. 7 is a top perspective view of the pouch assembly of FIG. 6, showing access to a pouch cavity thereof.

FIG. 8 is a fragmentary, top perspective view of the pouch assembly of FIG. 6 mounted to the leash assembly of FIG. 1.

FIGS. 9A-9D is a sequence of bottom perspective views showing mounting of the of the pouch assembly of FIG. 6 to the leash assembly of FIG. 1.

FIG. 10 is a front perspective view of the pouch assembly of FIG. 6.

FIG. 11 is a top perspective view of a collar pouch of the present invention mounted to a collar device.

FIG. 12 is a bottom perspective view of the collar pouch of FIG. 11.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

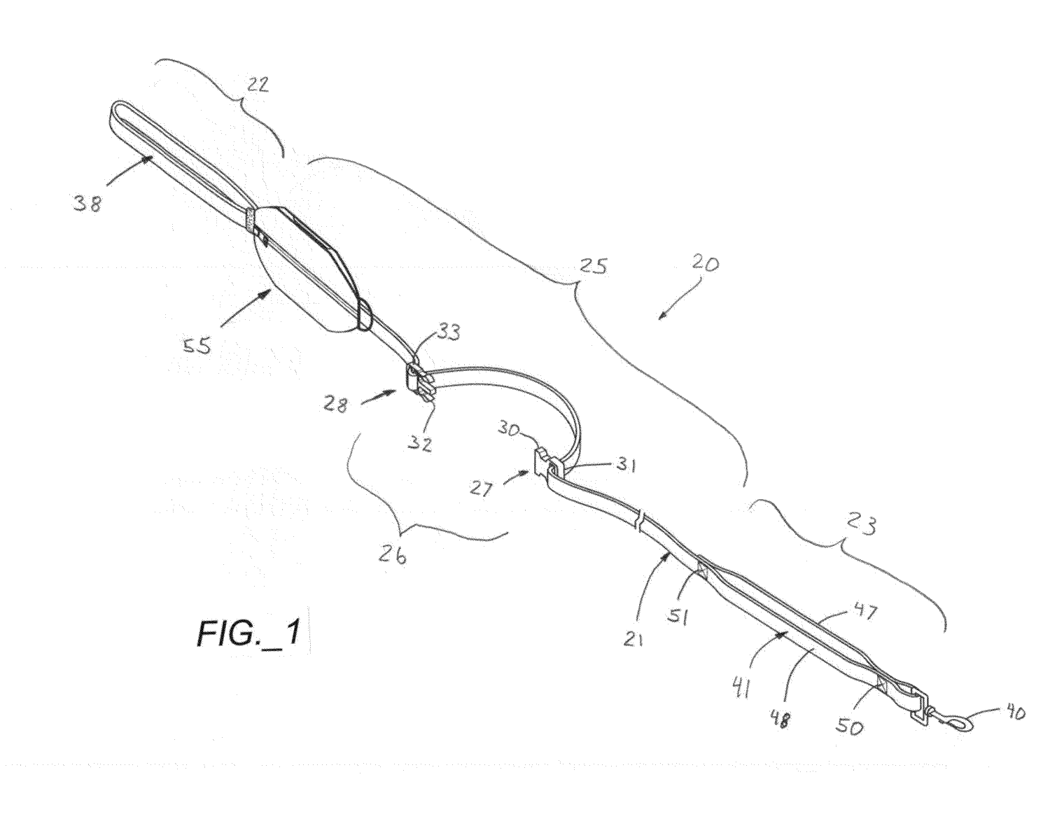

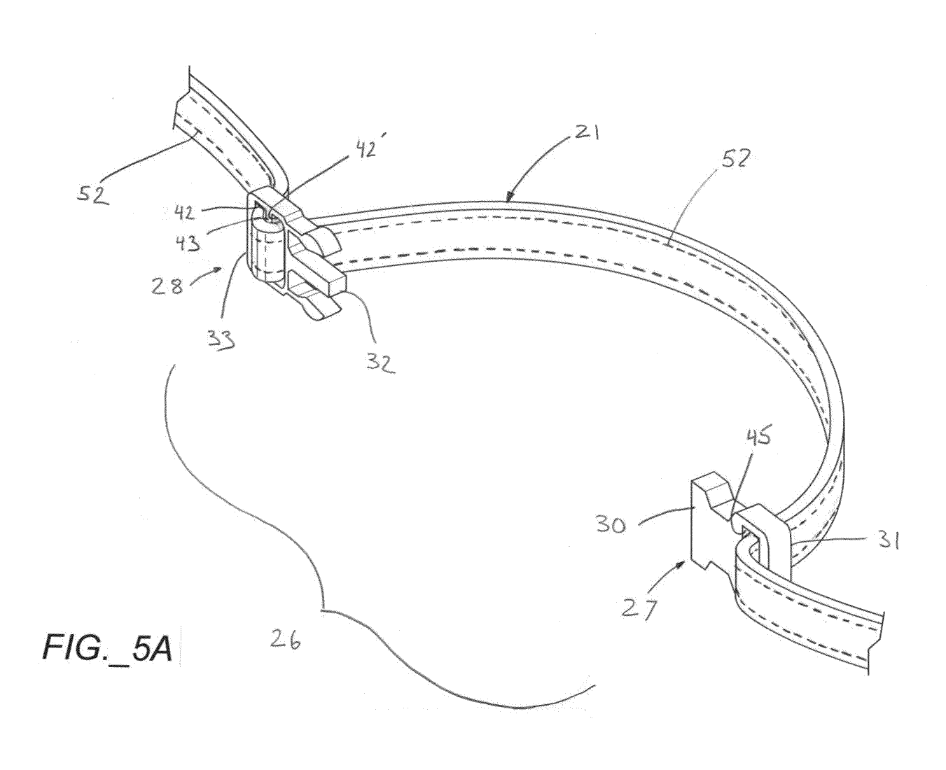

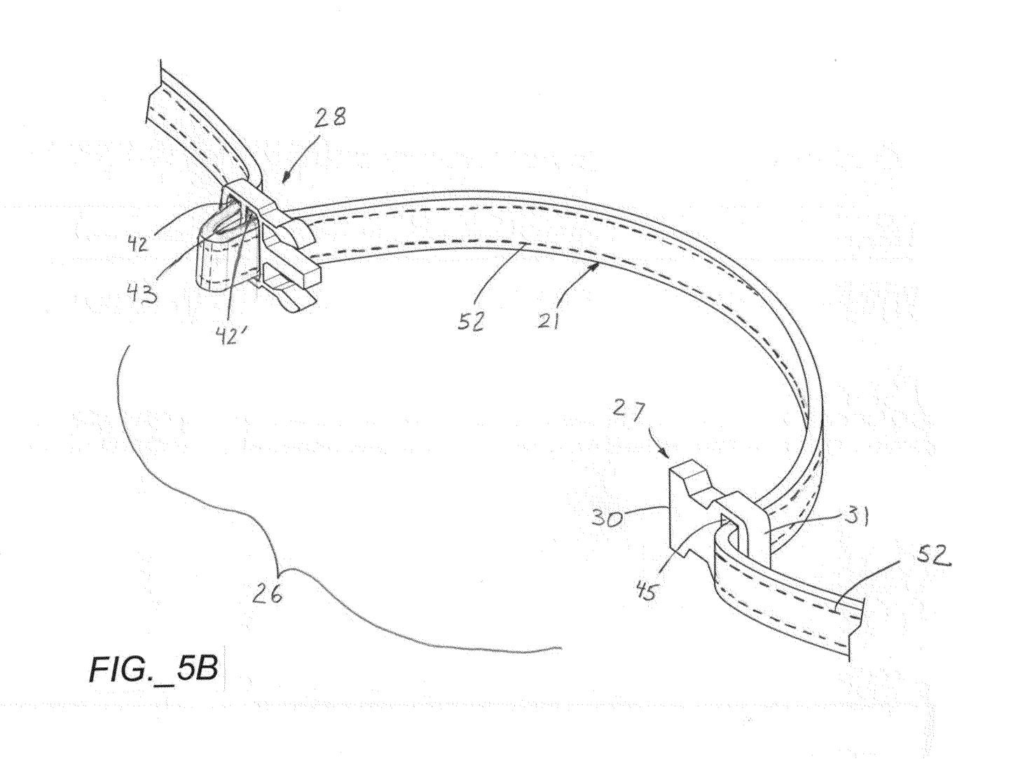

Turning now to FIGS. 1-5, a leash assembly, generally designated 20, is provided including an elongated strap device 21 having a proximal portion 22, a distal portion 23 and a central portion 25 generally extending between the proximal and distal portion thereof. The proximal portion of the strap device 21 is configured to enable gripping of the leash assembly thereof, and the distal portion is configured to removably couple to an animal (e.g., a dog (not shown)). The leash assembly 20 further includes a central quick release assembly, generally designated 26, having a slide fastener member 27 and a mating lock/slide fastener member 28. The slide fastener member 27 includes a first fastening component 30 and a slide portion 31 configured for selective sliding disposal at a plurality of positions along the strap central portion 25. The lock/slide fastener member 28, includes a second fastening component 32 adapted to releasably mate with the first fastening component 30. The lock/slide fastener member 28 additionally includes a lock/slide portion 33 capable of releasably locking to the strap device 21 in a first orientation (FIG. 5A), and is further capable of selective sliding disposal thereof at a plurality of positions along the strap central portion at a second orientation (FIG. 5B). The first and second fastening components 30, 32 cooperate to selectively retain the central portion of the strap device 21 to one of a plurality of varying diameter anchoring objects 35 (e.g., a pole).

Accordingly, the leash assembly of the present invention enables quick securing of an animal (e.g., a pet dog) to an object without having to unleash the animal from its collar in order to wrap the strap around the anchoring object. Not only does the present invention provide a much faster and more efficient manner in which to secure the animal to the object, but also provides a much safer technique in that at no time is the collared animal released from the leash. Another advantage of this leash design is the ability to tighten around a object. Simply by pulling on the leash will cause the central portion thereof to tighten or cinch around the anchoring object. This is advantageous sometimes because it prevents the leash from sliding all the way to the ground. When the leash assembly is cinched around an object at a desired height, the leash is easier to access without having to bend down. Furthermore, the leash may be prevented from resting on the bottom of poles, trees, fire hydrants, etc., that are frequently urine covered. Moreover, the distance that the animal is tethered from the anchoring object can be selectively adjusted by sliding the fastener members proximally and distally along the central portion of the strap device.

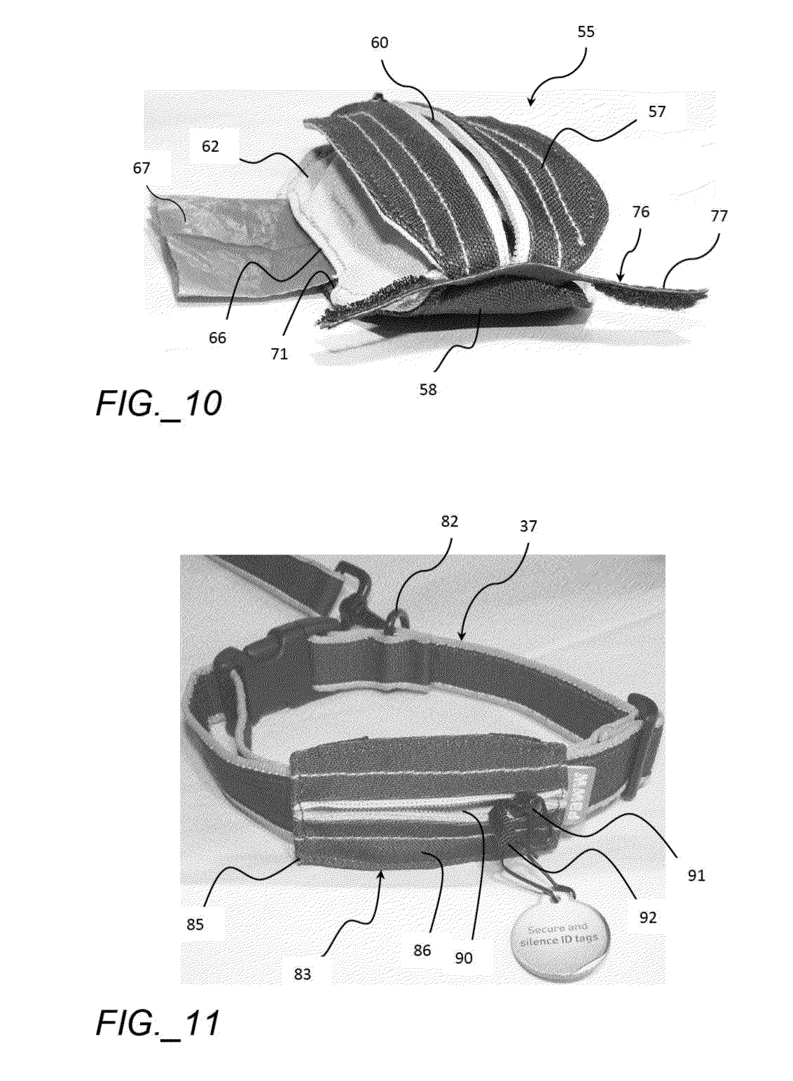

The leash assembly, in accordance with the present invention, may be used with any animal that a conventional collared leash is applied to. Typically, however, the present invention is particularly suitable for use with a domesticated pet such as a dog or cat. Moreover, the leash assembly of the present invention is generally used together with a conventional animal collar device 37, such as that shown in FIGS. 10 and 11.

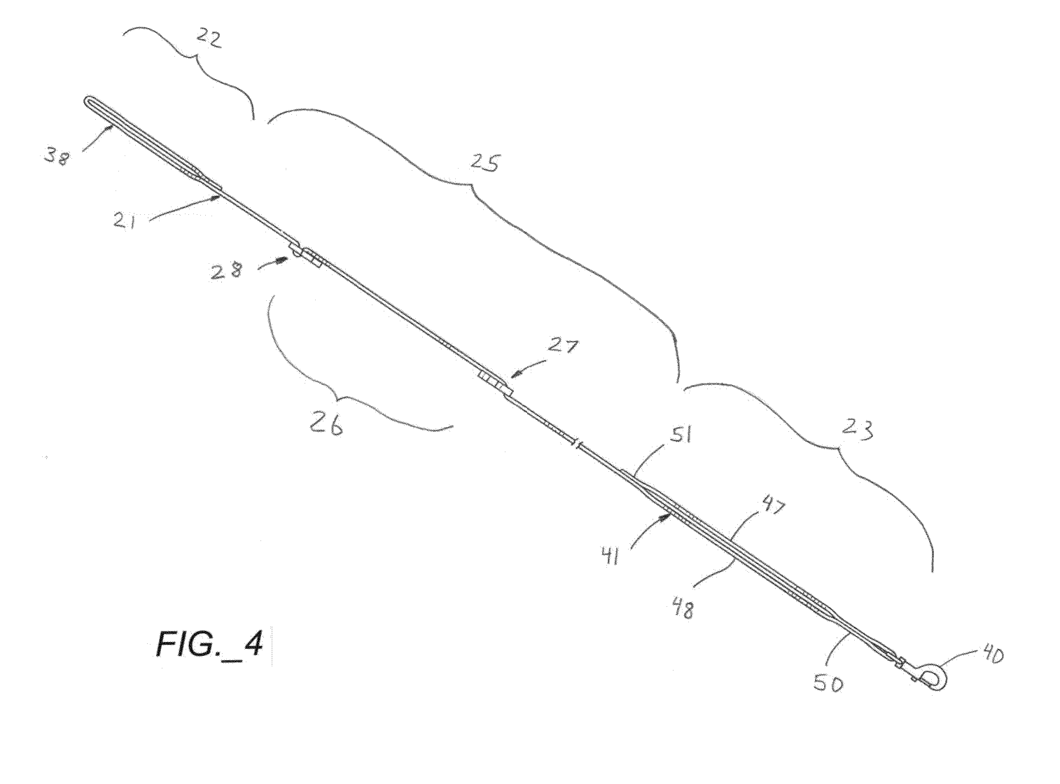

Referring back to FIGS. 1 and 4, the leash assembly 20 is primarily comprised of the elongated strap device 21 which may be of any length depending upon use. Typically, however, dog leashes are in the length of the around 5 feet to about 7 feet. Moreover, the strap device may be comprised of conventional leash material such as leather, natural materials and/or synthetic materials. One particularly suitable material for the strap device is a woven material such as nylon or cotton weaves.

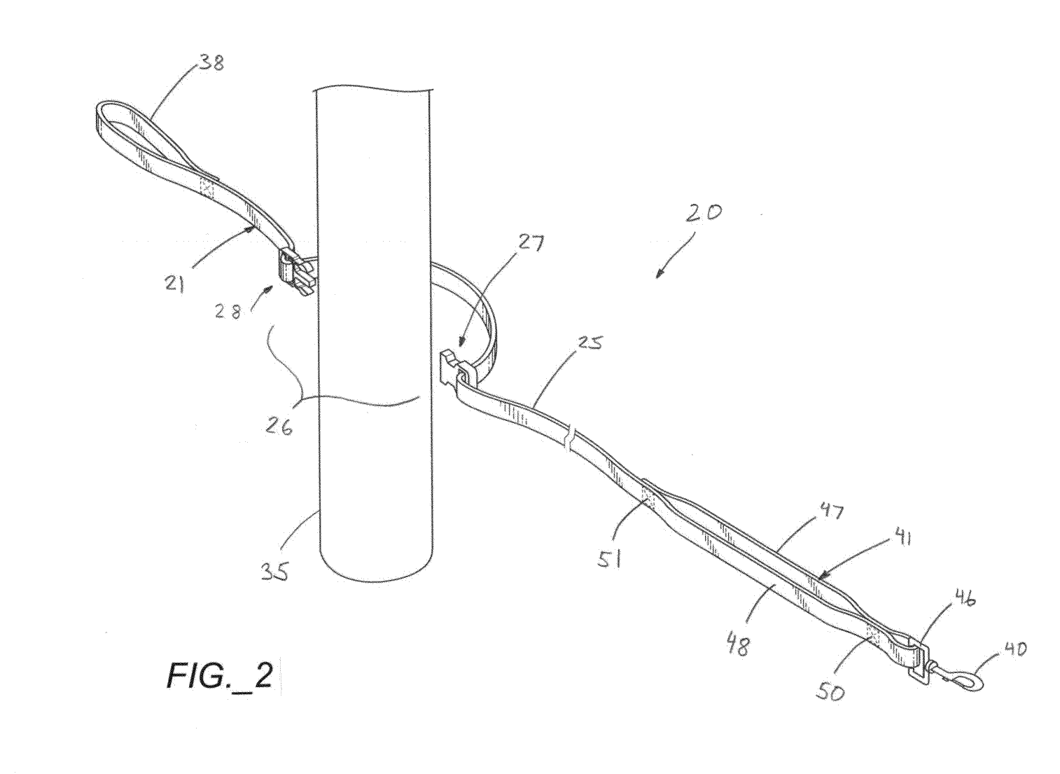

The strap device 21 of the leash assembly is separated into 3 parts for the ease of understanding. Briefly, as above-indicated, the strap device 21 includes the proximal portion 22, the central portion 25 and the distal portion 23. The strap proximal portion 22 includes a proximal hand loop 38, forming a conventional grip to hold and control the leash assembly, while the strap distal portion 23 includes a collar clip device 40 which is configured to clip to a conventional collar device 37 worn by the animal. Briefly, in accordance with the present invention, however, the strap distal portion 23 also defines a distal hand loop 41, as shown in FIGS. 2-4. Briefly, this distal control loop 41 is located very near the collar device 37 of the dog, enabling stricter handling and control or the dog by the owner, and thus, less freedom for the leashed animal. Finally, the strap central portion 25 extends between the strap proximal and distal portions 22, 23. This strap central portion primarily determines the length of the strap device, but also supports the quick release assembly 26, in accordance with the present invention.

Turning now to FIGS. 2, 3, and 5A and 5B, the quick release assembly 26 will be described in detail. As indicated, the quick release assembly enables quick securing of the strap device 21 of the leash assembly 20 to an anchoring object without having to unleash the animal from the leash assembly, as current leashes require. This is performed by providing two mating buckle components (i.e., the first and second fastening components 30, 32) along the strap central portion 25 that are slideably secured longitudinally along the strap device, and are formed and dimensioned to releasably attach to one another.

In accordance with the present invention, one of the fastening components is formed to freely slide along the strap central portion, while the other fastening component is formed and dimension to secure to the strap central portion in one orientation (FIG. 5A), and freely slide there along in another orientation (FIG. 5B). This configuration enables the lock/slide portion 33 to function as the anchor and secure the quick release assembly 26 along the strap central portion 25. In contrast, the sliding fastening component can be slid longitudinally along the strap central portion 25 in a manner permitting the user to easily and quickly adjust the length securing strap (i.e., the linear length of the strap material between the slide and lock/slide fastener members 27, 28) to accommodate anchoring objects of varying width and girth. Furthermore, slide fastener member 27 containing the lock/slide portion 33 can be slid longitudinally along the strap central portion at a plurality of positions in a manner selectively adjusting the length of the tethering of the animal to the anchoring object.

Preferably, the lock/slide fastener member 28 is oriented upstream from the slide fastener member 27, closer to the proximal hand loop 38 (FIGS. 1-3). Typically, the quick release assembly 26 will be oriented and operated closer to the proximal hand loop 38. Accordingly, placing the lock/slide fastener component closer to the hand loop is advantageous in that during the operation of the quick release assembly 26, the downstream slide fastener member 27 can be more easily operate and slid along the strap central portion to accommodate anchoring objects of increased girth.

As best shown in FIGS. 5A AND 5B, the lock/slide portion 33 includes a conventional 3-bar slide device that is utilized in many strap devices. This 3-bar slide device provides a fairly simple, yet effective, mechanism for locking the lock/slide fastener member 28 longitudinally along the strap central portion 25. When the strap device is pull through the opposing slots 42, 42′, from either side of the central bar 43, the strap central portion is pulled taught thereagainst, retaining the lock/slide fastener component along the strap device.

To loosen the lock/slide fastener component so that it can repositioned along the strap central portion 25, in either direction, portions the strap device can the positioned through the opposing slots 42, 42′ in a manner lifting the central strap from locked engagement and abutting contact with the central bar 43. Once the lock/slide portion 33 is properly repositioned, the strap central portion can be reengaged against the central bar 43 for locking thereagainst.

It will be appreciated that while the 3-bar slide device (i.e., the lock/slide portion 33) is the only lock/slide fastener component shown and described, other convention strap locking slide systems can be applied as well. Such other systems include, but are not limited to, safety seatbelt-type lock/slides, center push buckles, cam buckles and the like.

In contrast, the opposing slide portion 31 of the slide fastener member 27 of the quick release assembly 26 is provided by a conventional square link slide. This square link slide defines a strap passage 45 that is formed and dimensioned to enable unencumbered sliding of the strap central portion 25 therethrough. In accordance with the present invention, once the upstream lock/slide fastener member 28 is positioned and locked, the slide fastener member 27 can be easily slid along the strap central portion to accommodate anchoring object is varying shapes and girth.

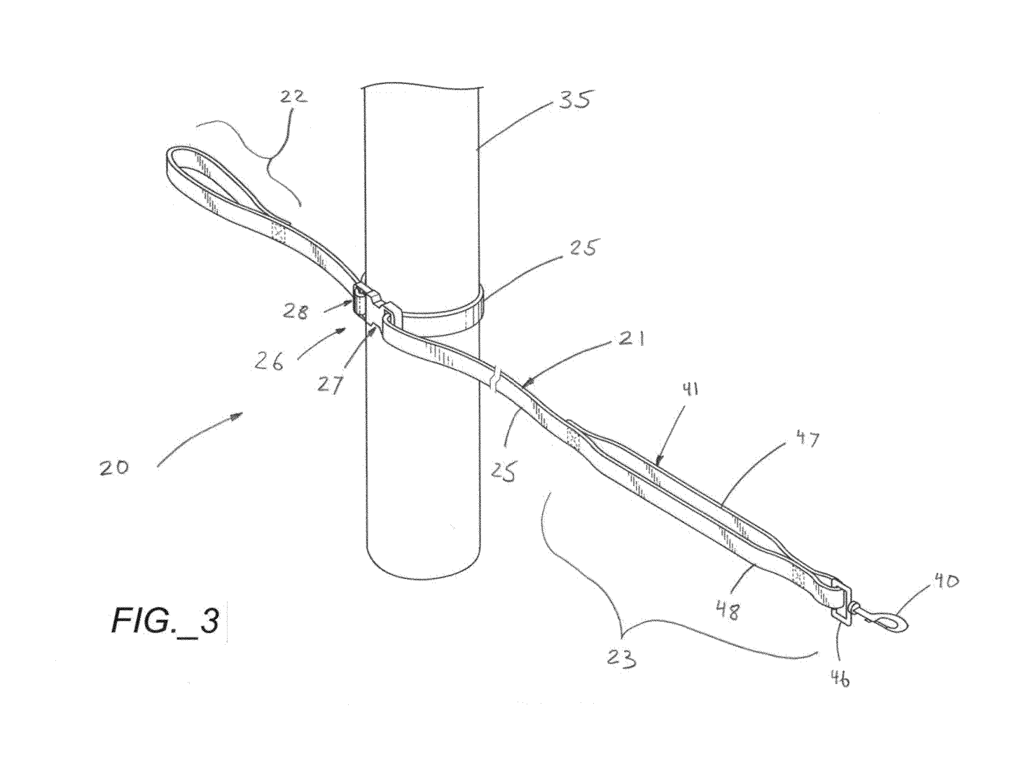

FIGS. 5A and 5B best illustrate that the first and second fastener components 30, 32 of the quick release assembly 26 include mating male-type and female-type buckle members that matingly engage one another. These mating fasteners releasably lock together, retaining the strap central portion 25 of the leash assembly 20 to the anchoring object 35. In one specific embodiment, the male-type buckle member (e.g., the second fastener component 32) is housed on the lock/slide fastener member 28, while of the female-type buckle member (e.g., the first fastener component 30) is housed on the opposing slide fastener member 27. It will be understood, that the male and female component can be reversed with respect to housing on the fastener components, but it will be appreciated that in either placement, the spaced-apart male and female components face or extend longitudinally toward one another. In this orientation, mating between the buckle members is thus facilitated (See FIGS. 2 and 3).

Referring back to FIGS. 2-4, the collar clip device 40 is mounted to the distal portion 23 of the strap device 21, via a proximal retaining loop 46 thereof. A first section 47 of the strap distal portion 23 extends through the retaining loop 46, and extends back towards and opposed to a second section 48 of the strap distal portion. The collar clip device is securely retained at the distal portion of the strap device 21 by affixing the first section 47 and the second section 48 to one another at a first mount 50 location just proximal to the retaining loop 46 of the collar clip. This is preferably performed by conventional sewing or stitching, but can be provided by adhesives, snaps, screws or any other technique.

As mentioned above, the distal portion of the strap device 21 may include a distal hand loop 41 as well. By extending the first section 47 of the strap distal portion 23 past the first mount 50, and mounting the distal end thereof at a second mount 51 location spaced-apart from the first mount, the distal hand loop 41 is formed. Accordingly, the size of the distal hand loop 41 can be easily controlled by adjusting the spacing between the first mount 50 and the second mount 51. For example, the spacing can be in the range of about ten inches. Similar to the first mount 50, the second mount is preferably using conventional sewing or stitching techniques, but can also be provided by adhesives, snaps, screws, etc., or any other technique.

In another aspect of the present invention, as illustrated in FIGS. 5A and 5B, one or more reflective threads or strands 52 may extend longitudinally along the woven material of the strap device. Such highly reflective strands significantly increase night visibility of the leash assembly when light, from an automobile, for instance, reflects off of the reflective stands 52. Such reflective strands can be interwoven in any pattern, but are shown as two parallel strands for illustrative purposes.

In yet another aspect of the present invention, a flexible pouch assembly, generally designated 55, is provided that is capable of releasably mounting to the leash assembly near the strap proximal portion 22. Briefly, turning now to FIGS. 1, 6 and 10, the flexible pouch assembly 55 includes an elongated, hollow body 56 extending generally along a longitudinal axis thereof. The hollow body 56 includes an upper sheet section 57 and an opposed lower sheet section 58 sewn or adhered together at the opposed proximal and distal ends thereof. The upper sheet section 57 defines an elongated access opening 60 into a cavity 61 of the hollow body.

The hollow body 56 further includes a pair of opposed side walls 62 extending between the upper sheet section 57 and the lower sheet section 58. Each of these side walls 62 includes at least one longitudinally extending central crease 63 such that when the hollow body 56 is empty, the hollow body 56 can be moved to a relatively flat, collapsed position (FIGURE yy). This allows for a convenient, flat storage or non-use position when the pouch is not in use.

Preferably, the respective central crease 63 folds inwardly, toward the body cavity 61, creating the smallest footprint when in oriented in the collapsed position. It will be appreciated that the central creases 63 could fold outwardly, or consist of more than one crease without departing from the true spirit and nature of the present invention.

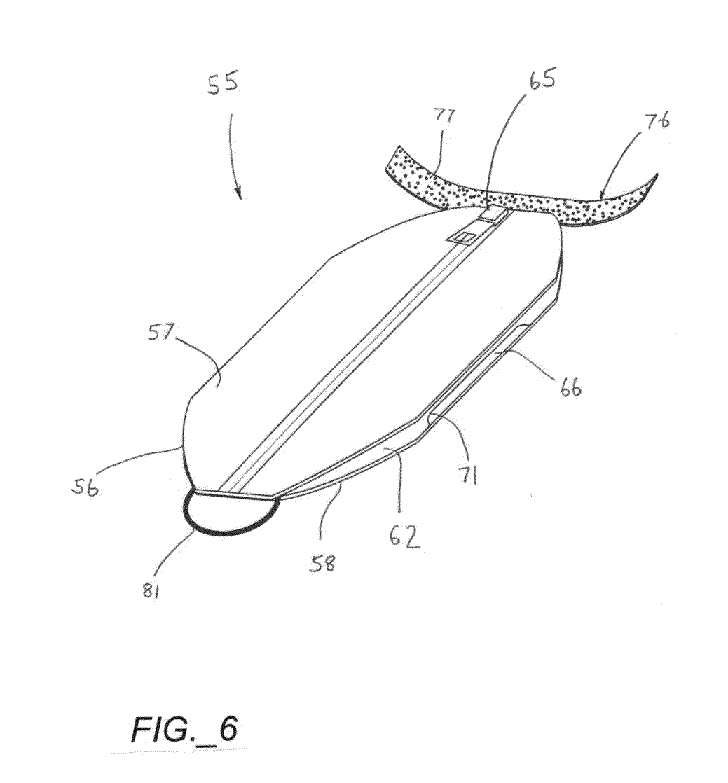

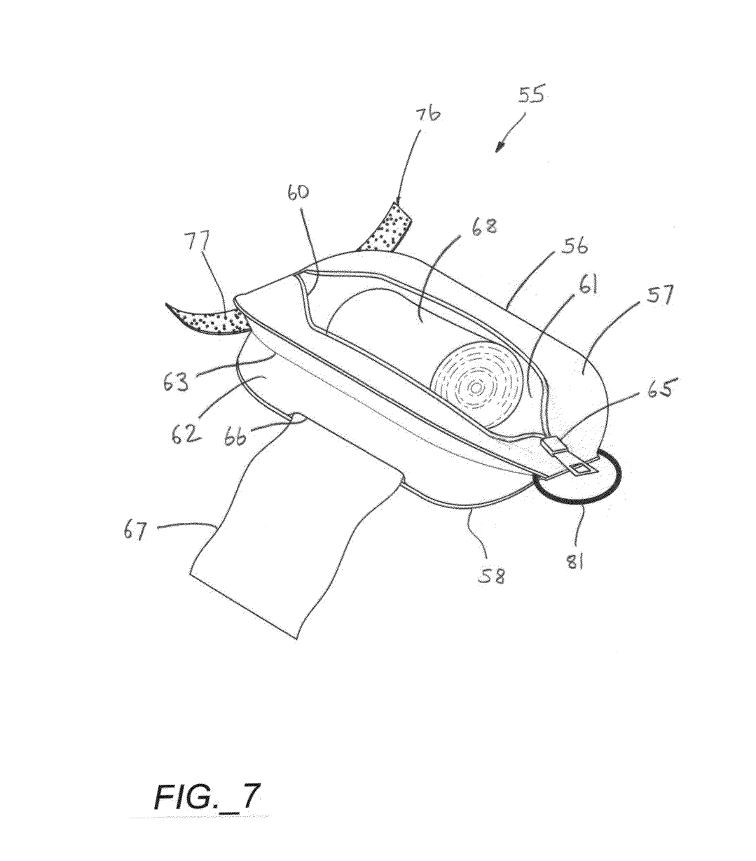

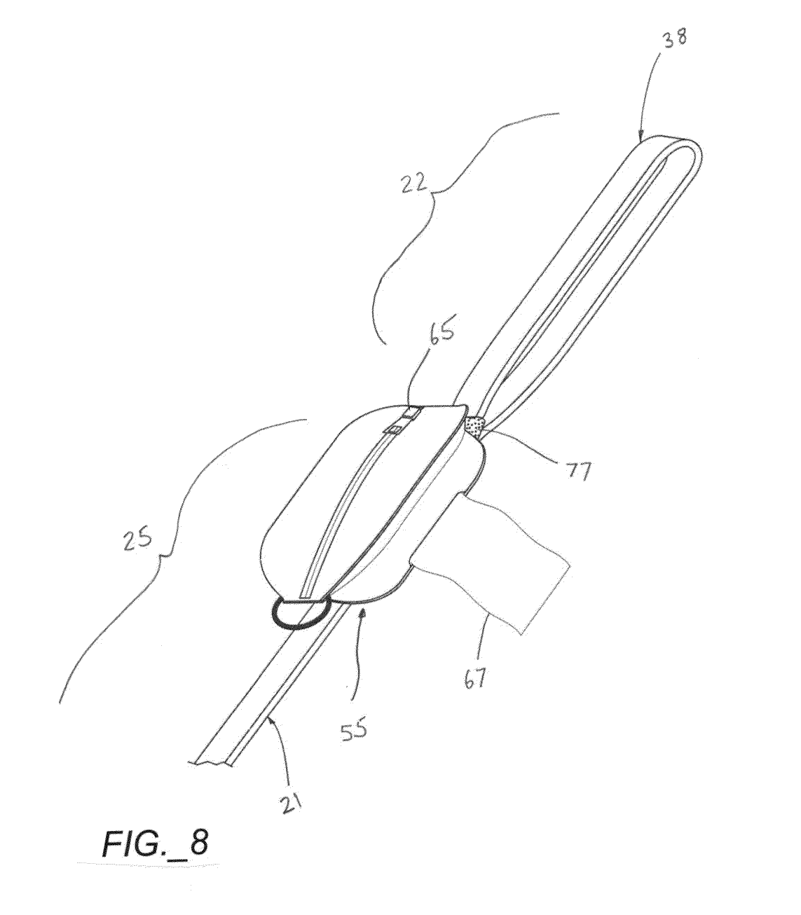

As best shown in FIGS. 6, 7 and 10, the elongated access opening 60 into the body cavity 61 of the flexible hollow body is generally provided by an elongated slit extending longitudinally along the upper sheet section 57. A fastener device 65 cooperates with the upper sheet section 57 for controlled closure of the access opening. Preferably, the fastener device 65 is provided by a conventional zipper-style fastener, although any other conventional fasteners can be applied such as buttons, hook and loop or latches.

In accordance with the present invention, one of the opposed sidewalls 62 defines an elongated dispensing slit 66 formed and dimensioned for dispensing a flatten sheet object 67 therethrough. In one specific embodiment, the flatten object 67 is part of a roll 68 of plastic bag material often applied to contain dog excrement. Thus, the body cavity 61 is configured to house the plastic bag roll 68 that is position therein through access opening 60. The distal end of the flatten plastic bag roll can be manipulated through the dispensing slit 66 for dispensing thereof as the roll is unraveled from within the pouch cavity.

One particular embodiment illustrates the formation of the dispensing slit 66 between the opposed edges or interface between one of the side walls 62 and the lower sheet section 58 of the hollow body 56. To facilitate greater access, either the lower sheet section 58, the side walls 62, or both, may have a small cutout section 71. Such a dispensing slit 66 could be provided at the opposed edges or interface between one of the side walls 62 and the upper sheet section 57 as well of course.

To provide closure of the dispensing slit 66, hook and loop, snap buttons, or latches, etc. are provided, although not shown.

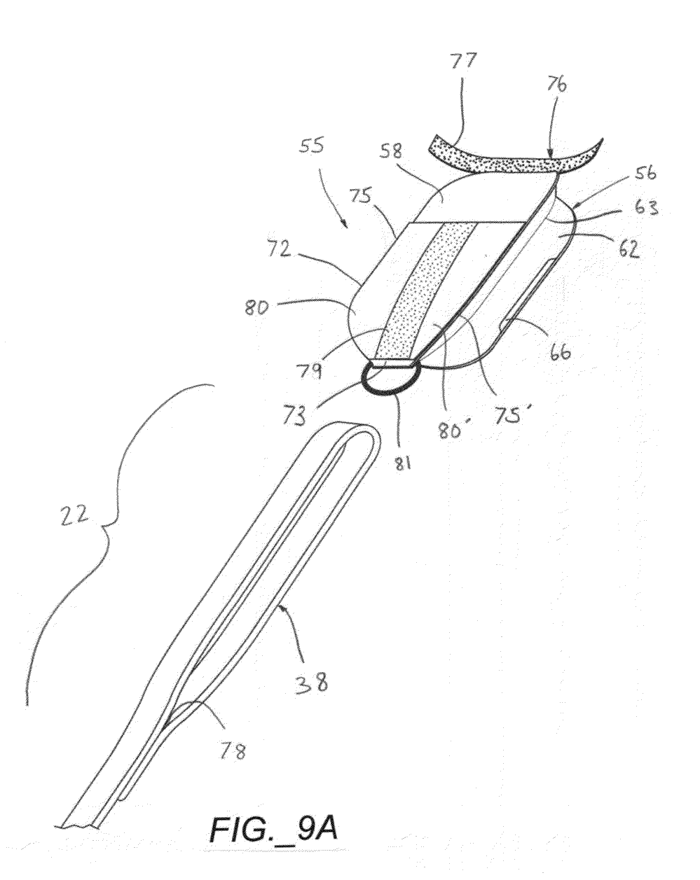

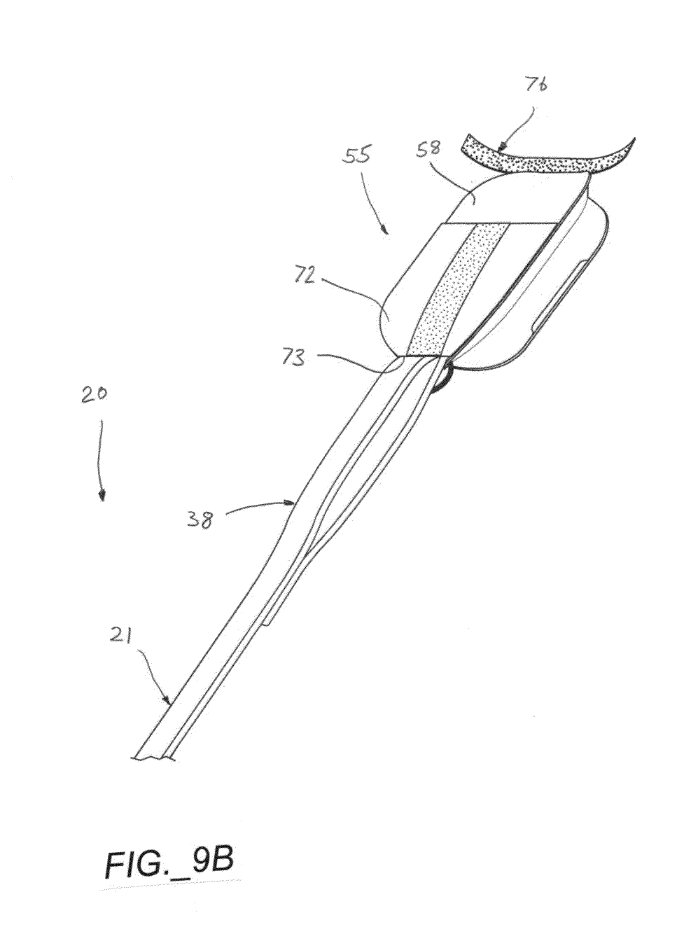

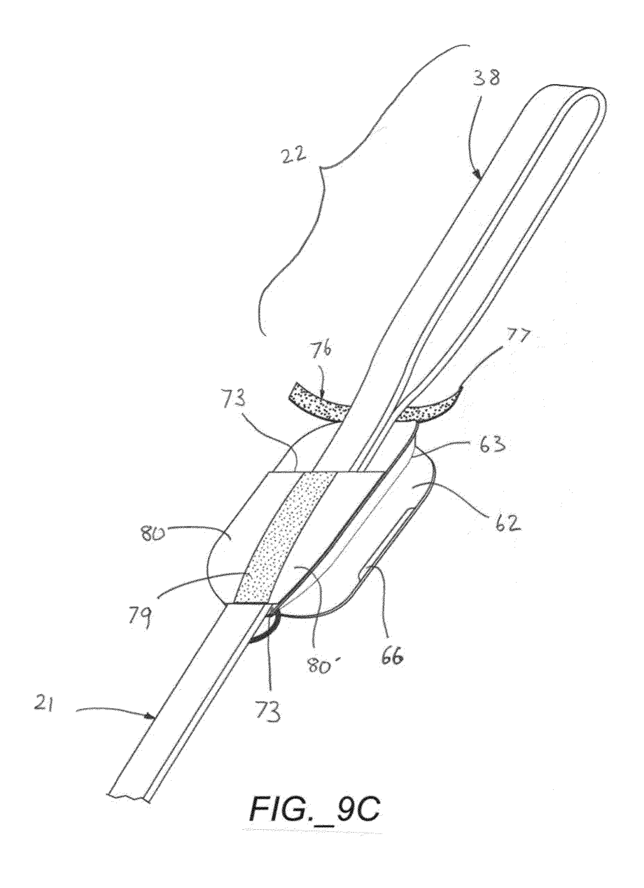

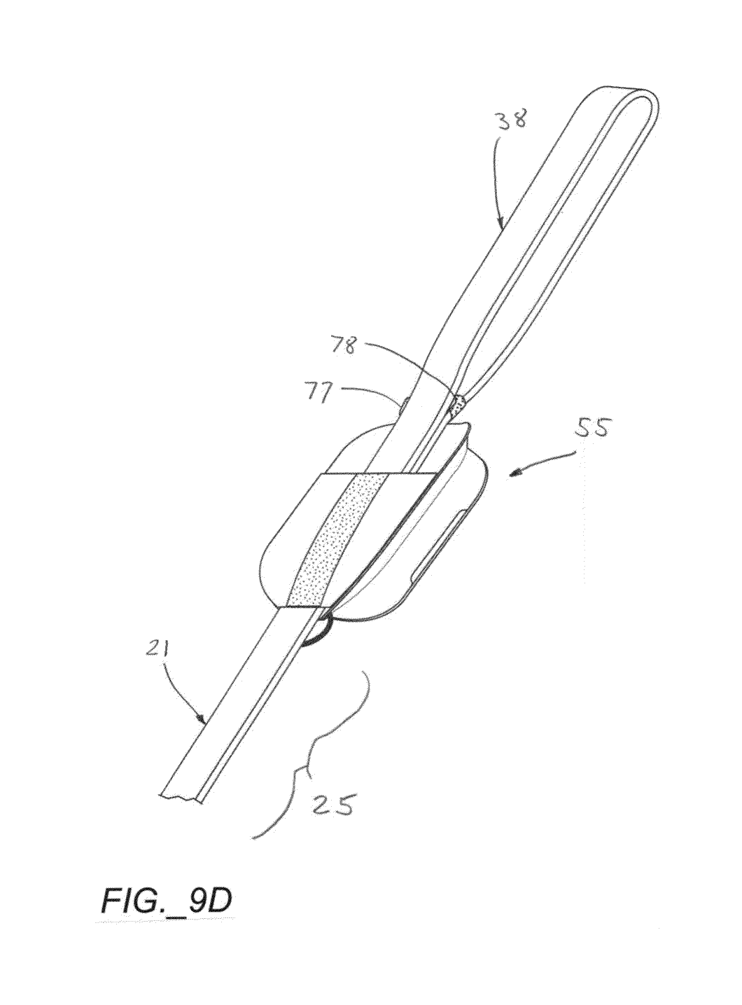

In accordance with the present invention, the flexible pouch assembly 55 is secured to the strap device 21 at the proximal portion 22 thereof. FIGS. 9A and 9B best illustrate that flexible pouch assembly 55 further includes a retaining sheet section 72 disposed adjacent to and cooperating with the lower sheet section 58 to form a longitudinally extending strap channel 73 extending generally in the direction of the longitudinal axis thereof. By disposing the retaining sheet section 72 adjacent and parallel to the lower sheet section 58, and affixing the adjacent side edges 75, 75′ together, via adhesive, sewing, etc., the longitudinal strap channel 73 can be provided which is sized and dimensioned for sliding receipt of a transverse cross-sectional dimension of the strap device therethrough (FIGS. 9B-9D).

The flexible pouch assembly 55, hence, is secured to the leash assembly 20, although it can slide freely longitudinally along the strap device otherwise. Accordingly, to prevent such slippage, a proximal mount device 76 is provided that is configured to removably mount to the proximal hand loop 38. In this manner, the pouch assembly 55 is retained to the hand loop 38 proximally along the strap proximal portion 22.

The proximal mount device 76 can be provided by a simple strap member 77 that is positioned through the hand loop 38. Once the strap member 77 is secured to and around the proximal hand loop 38, and the strap member 77 abuts and engages the intersecting trough 78 of the proximal hand loop 38, the pouch is prevented from sliding down the strap central portion 25 as the strap device. It will further be appreciated that the user could also elect to secure the pouch solely around the central portion of the leash (i.e. not through the handle). The pouch could then slide down the leash and reside near the distal clip. Some users might prefer to have the pouch “out of the way” in this manner.

FIG. 10 best illustrates that the strap member 77 is inter-sewn into a proximal seam of the upper and lower sheet sections 57, 58. Again, conventional hook and loop, snap buttons, buckles, latches, etc. can be provided to secure the components of the strap member removably together, and around the proximal hand loop 38.

To facilitate positioning of the strap device 21 through the strap channel 73, a resilient strip 78 of the retaining sheet section 72 can be provided which is capable of resilient stretching (FIGS. 9A-9D). This enables passage and receipt of the greater girth of the proximal hand loop 38 therethrough during mounting of the pouch assembly. Disposed on the opposed sides of the resilient strip 78 are material strips 80, 80′ which are similar in composition to the strap device 21 and the pouch assembly 55. Such materials include nylon weave strap material, as well as any other conventional strap materials.

A multipurpose loop 81 or the like can be include at the distal end of the flexible body. This multipurpose loop 81 can be for any convenience use such as, for instance, hanging the bag material dispensed from the pouch or keys, etc., therefrom, or can be used as a finger loop for independent carrying thereof, and is preferably comprised of an elastic material.

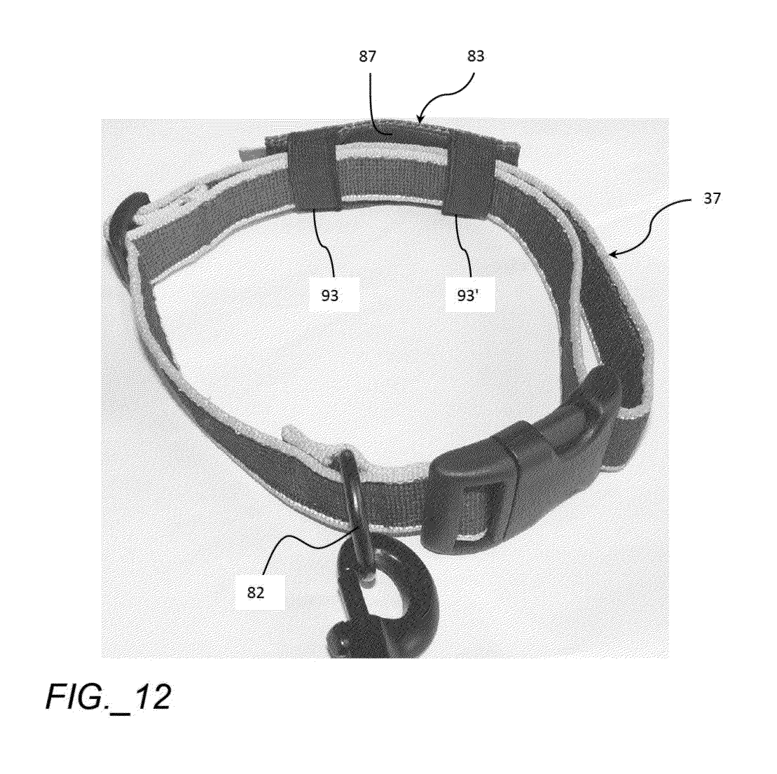

As mentioned, at the distal end of the leash assembly 20 is the collar clip device 40 which is configured to mount to a conventional animal collar device 37 (FIGS. 11 and 12). Preferably, the animal collar device 37 includes a leash loop 82 for releasable mounting thereto.

In still another aspect of the present invention, a small collar pouch 83 is included that is mountable to the animal's collar device 37. This small collar pouch 83 can be used to contain smaller objects such as keys or a dog tag. As best viewed in FIGS. 11 and 12, similar to the flexible pouch assembly, the collar pouch 83 includes an elongated, hollow body 85 configured to extend generally along the direction of the dog collar 37. The hollow body 85 is comprised of an upper sheet section 86 and an opposed lower sheet section 87 peripherally sewn or adhered together at the perimeter opposed edges thereof, forming a receiving cavity 88 therein.

Again, similar to the flexible pouch assembly 55, the upper sheet section 86 of the collar pouch 83 defines an elongated access opening 90 into the receiving cavity 88 of the hollow body which is more or less an elongated slit. A fastener device 91 cooperates with the collar pouch upper sheet section 86 for controlled closure of the access opening. Preferably, the fastener device 91 is provided by a conventional zipper-style fastener, although any other conventional fasteners can be applied such as buttons, hook and loop or latches.

A tether device 92 may be included in the collar pouch cavity 88 that is accessible through the access opening. A proximal end of the tether device may be secured to the pouch assembly from within the pouch cavity 88, while a distal end of the tether includes a multipurpose clip device 40. For example, keys or a dog identification tag may be secured thereto, and hidden within the collar pouch cavity when not needed.

To secure the collar pouch 83 to the animal collar device 37, one or more resilient securing straps 93, 93′ may be provided that enable securing thereto. These simple securing straps 93, 93′ extend transversely across the bottom of the lower sheet section 87, forming securing loops upon which the ends of the animal collar can be positioned therethrough.

Although the present invention has been described in connection with the preferred form of practicing it and modifications thereto, those of ordinary skill in the art will understand that many other modifications can be made thereto within the scope of the claims that follow. Accordingly, it is not intended that the scope of the invention in any way be limited by the above description, but instead be determined entirely by reference to the claims that follow.

What is claimed is:

1. A leash assembly comprising:
an elongated strap device having a proximal portion, a distal portion and a central portion generally extending between the proximal and distal portion thereof, said proximal portion being configured to enable gripping of the leash assembly thereof, and said distal portion being configured to removably couple to an animal; and
a quick release assembly having:
a slide fastener member having a first fastening component; and
a lock/slide fastener member having a second fastening component adapted to releasably mate with the first fastening component, said lock/slide fastener member further includes a lock/slide portion capable of releasably locking to the strap central portion in a first orientation, and capable of selective sliding disposal thereof at a plurality of positions along the strap central portion in a second orientation;
wherein said first and second fastening components cooperate to selectively retain said central portion of the strap device to one of a plurality of varying diameter anchoring objects.

2. The leash assembly according to claim 1, wherein
said first and second fastening components include corresponding press-fit buckle members configured for press-fit coupling to one another.

3. The leash assembly according to claim 2, wherein
one of the press-fit buckle members is a male-type buckle member and the other press-fit buckle member is a female-type buckle member.

4. The leash assembly according to claim 3, wherein
said male-type buckle member is oriented in a manner facing in the longitudinal direction toward the female-type buckle member.

5. The leash assembly according to claim 1, wherein
said first and second fastening components include corresponding snap members configured for snap-fit coupling to one another.

6. The leash assembly according to claim 1, wherein
said first and second fastening components include corresponding belt buckle members configured to couple to one another.

7. The leash assembly according to claim 1, wherein
said slide portion includes a square link slide device, and said lock/slide portion includes a three-bar slide device.

8. The leash assembly according to claim 1, further including:
a collar clip device having a proximal retaining loop; and
a first section of said distal portion of the strap device extends through said retaining loop, and extends back towards and opposed to a second section of said distal portion,
wherein said first section is affixed to said second section of the strap distal portion proximate to said retaining loop of said clip device, at a first mount, retaining the clip device at a distal end of the leash assembly, and
wherein said first section of the strap distal portion is mounted to the second section, at a second mount, spaced apart from said first mount and in a manner forming a distal hand loop proximate to the collar clip device.

9. The leash assembly according to claim 1, wherein,
a first section of said proximal portion of the strap device extends back towards and opposed to a second section of said proximal portion,
wherein said first section of the strap proximal portion is affixed to the second section, at a mount, spaced apart from a proximal end of said leash assembly and in a manner forming a proximal hand loop.

10. The leash assembly according to claim 9, further including:
a flexible pouch assembly having an elongated, hollow body extending generally along a longitudinal axis thereof, said hollow body including an upper sheet section and an opposed lower sheet section, said upper sheet section defining an opening into a cavity of the flexible body, said pouch assembly further including a retaining section disposed adjacent to said lower sheet section, and forming a strap channel extending generally in the direction of the longitudinal axis thereof, said strap channel sized and dimensioned for sliding receipt of a transverse cross-sectional dimension of the strap device therethrough.

11. The leash assembly according to claim 10, wherein
said pouch assembly includes a proximal mount device configured to removably mount to said proximal control loop in a manner retaining said pouch assembly proximally along said strap device.

12. The leash assembly according to claim 11, wherein
said proximal mount device includes a strap member.

13. The leash assembly according to claim 12, wherein
said hollow body including a pair of opposed side walls extending between the upper sheet section and the lower sheet section, each side wall includes a longitudinally extending central crease such that when said hollow body is empty, said hollow body can be moved to a relatively flat position.

14. The leash assembly according to claim 10, wherein
one of said sidewalls defines an elongated dispensing slit formed and dimensioned for dispensing a flatten object therethrough.

15. The leash assembly according to claim 10, wherein
said retaining section includes an elastic portion enabling resilient expansion of said strap channel.

16. The leash assembly according to claim 1, wherein
said lock/slide fastener member is oriented along the strap device upstream from the slide fastener member.

17. The leash assembly according to claim 1, wherein
said slide fastener member further includes a slide portion configured for selective sliding disposal at a plurality of positions along the strap central portion in a manner wherein said slide portion and said lock/slide fastener member enable length adjustment of a section of the strap central portion therebetween to accommodate the one of a plurality of varying diameter anchoring.

18. The leash assembly according to claim 1, wherein
said strap device includes at least one reflective thread extending longitudinally therealong.

19. A method of securing a collared animal to an object comprising:
providing a leash assembly having an elongated strap device with a proximal portion, a distal portion and a central portion generally extending between the proximal and distal portion thereof, said proximal portion being configured to enable gripping of the leash assembly thereof, and said distal portion being configured to removably couple to the collared animal;
positioning at least one of a slide portion of a slide fastener member and a lock/slide portion of a lock/slide fastener member longitudinally along said central portion of said elongated strap device;
extending a section of the strap central portion that extends between the slide fastener member and the lock/slide fastener member around an anchoring object; and
fastening a first fastening component of the slide fastener and a second fastening component of the lock/slide fastener member to one another, mounting said leash assembly around said anchoring object and retaining said collared animal thereto.

20. The method according to claim 16, further including:
pulling one of the proximal portion and the central portion to tighten the strap section around the central object.
